(19) United States
(12) Patent Application Publication
(10) Pub. No.: US 2026/0043648 A1
(43) Pub. Date: Feb. 12, 2026

(54) SYSTEMS AND METHODS FOR ROAD ROUGHNESS MEASUREMENT

(71) Applicant: Ford Global Technologies, LLC, Dearborn, MI (US)

(72) Inventors: Amirhassan Abbasi, Farmington, MI (US); Arianna Duraku, Shelby Township, MI (US); Satheesh Kumar Chandran, Livonia, MI (US); Vicky Svidenko, Newcastle, WA (US); Matt Black, Manchester, MI (US)

(73) Assignee: Ford Global Technologies, LLC, Dearborn, MI (US)

(21) Appl. No.: 18/797,270

(22) Filed: Aug. 7, 2024

(51) Int. Cl. G01B 17/08

(52) U.S. Cl. CPC G01B 17/08

(57) ABSTRACT

A vehicle having a plurality of road noise cancellation sensors captures vibration data as it is travelling along a road. The vehicle checks to see whether a set of operating conditions for the vehicle are satisfied. If the set of operating conditions are satisfied, the vehicle determines the portion of the vibration data that was captured during the time frame in which the set of operating conditions was satisfied. The vehicle may then use the portion of the vibration data to extract feature data for one of more features. The vehicle then uses the feature data associated with the one or more features to determine a roughness indicator for the road that it is currently travelling on. This road roughness indicator measurement may be used to trigger further analysis of the vibration data for determining other parameters of the vehicle.

### FIELD

The present disclosure relates to the field of real-time road roughness measurement by a vehicle.

### BACKGROUND

Traditional road roughness measurement techniques like the International Roughness Index (IRI) have several issues. The IRI is based on the reaction of a standard-sized car to the pavement roughness. However, actual cars vary in size and may differ from the ideal car used in the definition of IRI. As a result, recordings made in different-sized cars can lead to estimates that are somewhat different from the IRI. Further, roughness measuring methods have not been stable over time. Measures made today with road meters cannot be compared with confidence to those made several years ago. Roughness measurements have not been transportable. Road meter measures made by one system are seldom reproducible by another. Recent studies have shown inconsistencies in IRI results, including bias, random error, and disagreement between devices.

These challenges suggest that while the IRI is a useful tool, it may not be sufficient to properly describe road roughness in all scenarios. Some researchers propose supplementing IRI with additional numerical characteristics, such as the power-law exponent that describes how the effect of roughness changes when we change the size of the vehicle.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a block diagram of a vehicle according to an embodiment of the present disclosure.

FIG. 2 illustrates a portion of a vehicle including the vibration detection sensor according to an embodiment of the present disclosure.

FIG. 3 illustrates a block diagram for a system for road roughness measurement according to an embodiment of the present disclosure.

FIGS. 4A and 4B illustrate vibration data for two different types of roads according to an embodiment of the present disclosure.

FIGS. 5A-5D illustrate feature data determined from the vibration data for the four wheels of a vehicle according to an embodiment of the present disclosure.

FIG. 6 illustrates a flow chart for determining road roughness according to an embodiment of the present disclosure.

FIG. 7. Illustrates a block diagram of server according to an embodiment of the present disclosure.

### DETAILED DESCRIPTION

### Overview

The present disclosure describes systems and methods for real-time measurement of road roughness. The determination of the state of the road may then be used as a trigger condition for collecting and/or analyzing other vehicle data that may be used in various other determinations.

In some instances, a method performed by vehicle is provided that can determine a measure of the roughness of the road that it is currently travelling on in real time. The method includes the vehicle determining that the vehicle is in motion on a road. During that motion, the vehicle may capture vibration data associated with the vehicle using a plurality of sensors of the vehicle. The method may further include the vehicle determining operational data associated with the vehicle and based on the operational data, the vehicle may determine that a set of operational conditions are satisfied. The method may further include the vehicle determining one or more features using the vibration data and based on the set of operational conditions being satisfied. Thereafter the method may include the vehicle determining a roughness indicator for the road based on the one or more features.

In another instance, a vehicle is provided that include multiple accelerometers or road noise cancellation sensors attached at various locations of the vehicle. The vehicle also includes one or more processors that work in conjunction with the sensors to determine that the vehicle is in motion on a road. The vehicle may also capture vibration data associated with the vehicle using the sensors. The one or more processors may further determine operational data associated with the vehicle and based on the operational data, determine that a set of operational conditions are satisfied. Based on the set of operational conditions being satisfied, the one or more processors use the vibration data to determine one or more features associated with the vibration data. In addition, the one or more processors may determine a roughness indicator for the road based on the one or more features.

In yet another instance, a vehicle is provided that can determine a measure of the roughness of a road in real-time. First, the vehicle determines that the vehicle is currently in motion on a road. The vehicle then receives vibration data associated with the vehicle from a plurality of sensors that are coupled to the vehicle. After receiving the vibration data, the vehicle determines that a set of operating conditions associated with the vehicle are satisfied for a first time duration. Thereafter, the vehicle determines a first portion of the vibration data associated with the first time duration and using the first portion of the vibration data, the vehicle further determines one or more features associated with the first portion of the vibration data. Finally, the vehicle determines a roughness indicator for the road based on the one or features.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

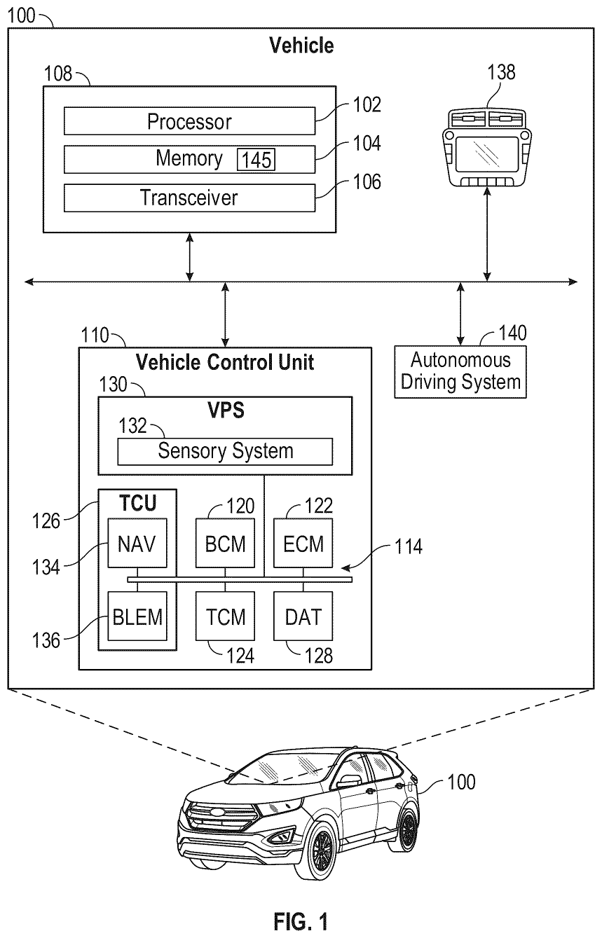

FIG. 1 illustrates a block diagram of a vehicle 100 in which embodiment of the present disclosure can be implemented. The vehicle 100 may include a plurality of units including, but not limited to, an automotive computer 108, a Vehicle Control Unit (VCU) 110, and an infotainment unit 138. The VCU 110 may include a plurality of Electronic Control Units (ECUs) 114 disposed in communication with the automotive computer 108.

In some embodiments, a user device, such as a mobile phone, a laptop computer, or the like may be configured to connect with the automotive computer 108, which may communicate via one or more wireless connection(s), and/or may connect with the vehicle 100 directly by using near field communication (NFC) protocols, Bluetooth® protocols, Wi-Fi, Ultra-Wide Band (UWB), and other possible data connection and sharing techniques.

The automotive computer 108 may be installed anywhere in the vehicle 100, in accordance with the disclosure. The automotive computer 108 may be or include an electronic vehicle controller, having one or more processor(s) 102, one more memories 104, and one or more transceivers 106.

The processor(s) 102 may be disposed in communication with one or more memory devices disposed in communication with the respective computing systems (e.g., the memory 104 and/or one or more external databases not shown in FIG. 1). The processor(s) 102 may utilize the memory 104 to store programs in code and/or to store data for performing operations in accordance with the disclosure. The memory 104 may be a non-transitory computer-readable storage medium or memory storing a vehicle control program code. The memory 104 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 104 may include a module 145 that can implement the various embodiments of the present disclosure. Module 145 may include instructions that can be executed by the processor 102 to realize the various embodiments of the present disclosure.

Automotive computer 108 may also include a transceiver 106. The transceiver 106 may be configured to receive information/inputs from one or more external devices or systems, e.g., a user device 108, an external server, and/or the like. Further, the transceiver 106 may transmit notifications, requests, signals, etc. to the external devices or systems. In addition, the transceiver 106 may be configured to receive information/inputs from vehicle components such as the vehicle sensory system 132, one or more ECUs 114, and/or the like. Further, the transceiver 106 may transmit signals (e.g., command signals) or notifications to the vehicle components such as the BCM 120, the infotainment system 138, and/or the like.

In some embodiments, the VCU 110 may share a power bus with the automotive computer 108 and may be configured and/or programmed to coordinate the data between vehicle systems, connected servers and/or the like. The VCU 110 may include or communicate with any combination of the ECUs 114, such as, for example, a Body Control Module (BCM) 120, an Engine Control Module (ECM) 122, a Transmission Control Module (TCM) 124, a Telematics Control Unit (TCU) 126, a Driver Assistances Technologies (DAT) controller 128, etc. The VCU 110 may further include and/or communicate with a Vehicle Perception System (VPS) 130, having connectivity with and/or control of one or more vehicle sensory system(s) 132. The vehicle sensory system 132 may include one or more vehicle sensors including, but not limited to, a Radio Detection and Ranging (RADAR or “radar”) sensor configured for detection and localization of objects inside and outside the vehicle 100 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, road noise cancellation (RNC) sensors, etc. The sensors that are part of the vehicle sensory system 132 may be coupled to the vehicle 100 at one or more locations and in one or more manner. For example, the various sensors of the vehicle sensory system 132 may be integrated into the various subsystems of the vehicle 100, such as doors, mirrors, roof, underbody components, etc. or attached to the vehicle 100 using an appropriate mounting mechanism. In some embodiments, the various sensors of the vehicle sensory system 132 may be located at the front, back, sides, top, bottom, and underneath the vehicle 100. The location of a sensor may depend on its function. For example, a sensor that monitors the area underneath the vehicle may be connected to a bottom surface of the vehicle 100 while a sensor that can monitor an area to either side of the vehicle 100 may be mounted or integrated into the doors of the vehicle 100. Vehicle sensory system 132 may also include one or more road noise sensors such as accelerometers that are coupled to various mechanical components and/or systems of the vehicle 100. One skilled in the art will realize that the sensors may be coupled to the vehicles in various different ways and locations other than the ones mentioned above.

In some embodiments, the VCU 110 may control vehicle operational aspects and implement one or more instruction sets received from the server 106, the user device 108, or from one or more instruction sets stored in the memory 104.

The TCU 126 may be configured and/or programmed to provide vehicle connectivity to wireless computing systems onboard and off board the vehicle 100, and may include a Navigation (NAV) receiver 134 for receiving and processing a GPS signal, a BLE® Module (BLEM) 136, a Wi-Fi transceiver, a UWB transceiver, and/or other wireless transceivers (not shown in FIG. 1) that may be configurable for wireless communication (including cellular communication) between the vehicle 100 and other systems (e.g., a vehicle key fob (not shown in FIG. 1), an external server, a user device, etc.), computers, and modules. The TCU 126 may be in communication with the ECUs 114 by way of a bus. In some aspects, the TCU 126 may be configured to determine a real-time vehicle geolocation, e.g., via the NAV receiver 134.

The ECUs 114 may control aspects of vehicle operation and communication using inputs from human drivers, inputs from the automotive computer 108, and/or via wireless signal inputs received via the wireless connection(s) from other connected devices, such as the server 106, among others.

The BCM 120 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, etc. The BCM 120 may also operate as a gateway for bus and network interfaces to interact with remote ECUs (not shown in FIG. 1).

The DAT controller 128 may provide Level-1 through Level-3 automated driving and driver assistance functionality that may include, for example, active parking assistance, vehicle backup assistance, and/or adaptive cruise control, among other features. The DAT controller 128 may also provide aspects of user and environmental inputs usable for user authentication.

In some embodiments, the automotive computer 108 may connect with an infotainment system 138 (or a vehicle Human-Machine Interface (HMI)). The infotainment system 138 may include a touchscreen interface portion, and may include voice recognition features, biometric identification capabilities that may identify users based on facial recognition, voice recognition, fingerprint identification, or other biological identification means. In other aspects, the infotainment system 138 may be further configured to receive user instructions via the touchscreen interface portion, and/or output or display notifications, navigation maps, etc. on the touchscreen interface portion.

The computing system architecture of the automotive computer 108 and/or the VCU 110 may omit certain computing modules. It should be readily understood that the computing environment depicted in FIG. 1 is an example of a possible implementation according to the present disclosure, and thus, it should not be considered as limiting or exclusive.

In some embodiments, vehicle 100 may include an autonomous driving system 140. Vehicle 100 may be manually driven or configured to operate, using the autonomous driving system 140, in a fully autonomous (e.g., driverless) mode (e.g., Level-5 autonomy) or in one or more partial autonomous modes which may include driver assist technologies. Examples of partial autonomous (or driver assist) modes are widely understood in the art as autonomy Levels 1 through 4. For example, a vehicle having Level-1 autonomy may include a single automated driver assistance feature, such as steering or acceleration assistance. Adaptive cruise control is one such example of a Level-1 autonomous system that includes aspects of both acceleration and steering.

Level-2 autonomy in vehicles may provide driver assist technologies such as partial automation of steering and acceleration functionality, where the automated system(s) are supervised by a human driver who performs non-automated operations such as braking and other controls. In some embodiments, with Level-2 autonomous features and greater, a primary user may control the vehicle while the user is inside of the vehicle, or in some example embodiments, from a location remote from the vehicle but within a control zone extending up to several meters from the vehicle while it is in remote operation.

Level-3 autonomy in a vehicle can provide conditional automation and control of driving features. For example, Level-3 vehicle autonomy may include “environmental detection” capabilities, where the autonomous vehicle (AV) can make informed decisions independently from a present driver, such as accelerating past a slow-moving vehicle, while the present driver remains ready to retake control of the vehicle if the system is unable to execute the task.

Level-4 AVs can operate independently from a human driver, but may still include human controls for override operation. Level-4 automation may also enable a self-driving mode to intervene responsive to a predefined conditional trigger, such as a road hazard or a system event.

Level-5 AVs may include fully autonomous vehicle systems that require no human input for operation and may not include human operational driving controls.

In addition to the components noted above, the vehicle 100 may have numerous mechanical systems and sub-systems. A chassis or frame may form the backbone of the vehicle 100 and support the body and other components of the vehicle 100. The vehicle 100 may include an engine that converts fuel into mechanical power, propelling the vehicle forward. The engine includes various components such as the engine block, pistons, valves, and spark plugs. The vehicle 100 also includes a transmission system. The transmission system transfers the engine's power to the wheels. It includes the clutch, gearbox, driveshaft, and differentials, among other components. The transmission adjusts the power output to suit the vehicle's speed and load. The vehicle 100 may also include a suspension system. The suspension system absorbs shocks and maintains contact between the tires and the road, providing a smooth ride. It includes components such as springs, shock absorbers, and linkages. The vehicle 100 also includes a braking system that allows the driver to slow down or stop the vehicle 100. It includes components like brake pedals, master cylinder, brake lines, and brake pads or shoes. The vehicle 100 also includes a steering system that enables the driver to guide the car. The steering system includes components such as the steering wheel, steering column, rack and pinion, and tie rods. The vehicle 100 also includes an exhaust system that removes and filters the waste gases produced by the engine. It includes the exhaust manifold, catalytic converter, muffler, and tailpipe, among other components. The vehicle 100 also includes a cooling system that prevents the engine from overheating. It includes components such as the radiator, water pump, thermostat, and coolant. The vehicle 100 also includes a cooling system that stores and supplies fuel to the engine. It includes the fuel tank, fuel pump, fuel filter, and fuel injectors. An electrical system of the vehicle 100 powers the car's electrical components. It includes the battery, alternator, starter motor, and wiring. The Heating, Ventilation, and Air Conditioning (HVAC) system regulates the temperature inside the vehicle 100. It includes the heater core, blower motor, and air conditioning compressor. All of the mechanical components working together ensure that the vehicle operates smoothly and satisfactorily.

During operation, the vehicle 100 is subject to the road conditions and may experience vibration based on the quality of the road. These vibrations have an influence over the working and life-span of several vehicle components, especially, the mechanical and electrical components that are located on the underside of the vehicle, commonly referred to as “underbody components and systems.” It is beneficial to accurately measure the roughness of the road in real-time to as to understand the influence of the road and resulting vibrations on these components. In addition, a real-time measurement of the rough roughness can also help in determining when to collect other types of data for the vehicle for various types of vehicle related analyses. Thus, in one embodiment, the measure of the road roughness can act as a decision point, which may determine whether other vehicle-related measurements are to be made.

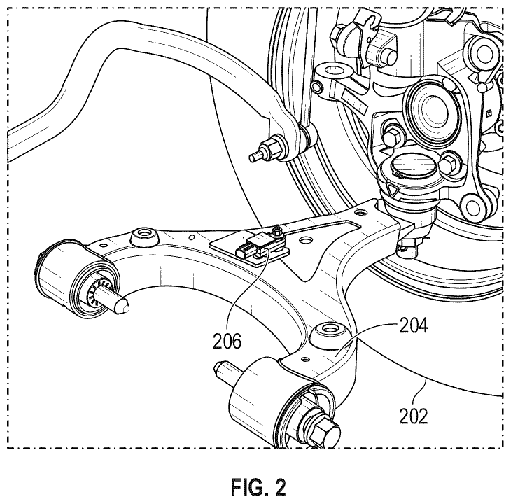

FIG. 2 illustrates an example setup of how the vibration data may be captured to determine road roughness according to an embodiment of the present disclosure. FIG. 2 illustrates a wheel 202 of a vehicle, e.g., vehicle 100 of FIG. 1. A control arm 204 is attached to the wheel 202 and a sensor 206, such as a road noise cancellation sensor, may be attached to the control arm 204. This setup may be repeated for all four wheels of the vehicle. This will result in four sensors 206, each attached to its respective control arm. It is to be noted that additional sensors 206 may also be placed on the underside of the vehicle in other locations to collect the vibration data. In an embodiment, each sensor 206 may measure acceleration along three directions, x, y, and z, thus effectively producing three channels of data. Combined, the four sensors may output twelve (12) channels of data. The subsequent processing may or may not use all this data outputted by the four sensors. In one embodiment, the sensors 206 may communicate their data on the Automotive Audio Bus (A2B). The A2B is well-known in the art and explanation of this technology is omitted here for brevity.

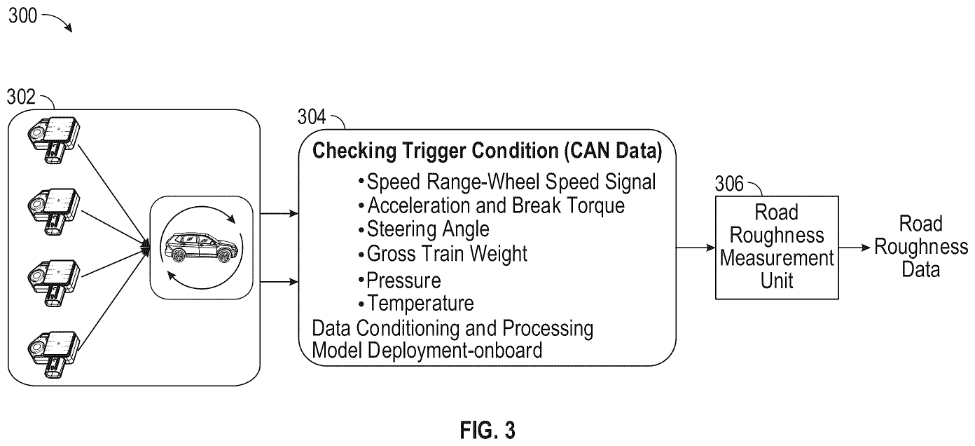

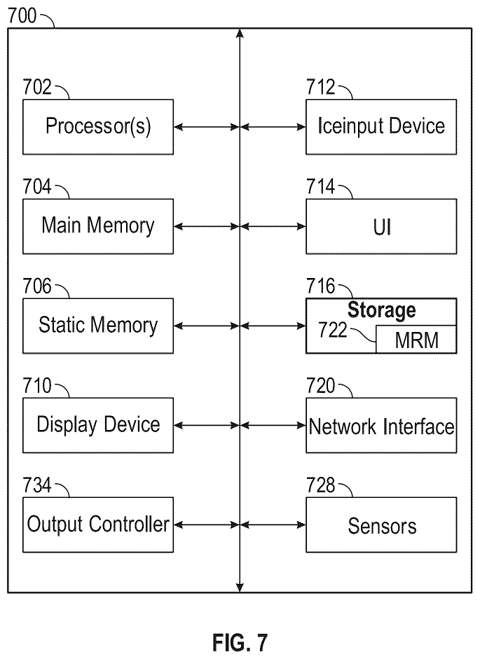

FIG. 3 illustrates a block diagram of a system 300 for measuring road roughness according to an embodiment of the present disclosure. System 300 may be entirely implemented, e.g., in the vehicle 100, or may be implemented partially in the vehicle and partially within an external server, e.g., server 700 of FIG. 7. System 300 includes a data collection unit 302. The data collection unit may include one or more road noise cancellation sensors located at multiple locations throughout the vehicle. In an embodiment, there may be four road noise cancellation sensors each outputting three channels of data. In addition to the vibration data collected by the road noise cancellation sensors, the data collection unit may also receive data about the vehicle operating conditions from a Controller Area Network (CAN) bus of the vehicle. The data received via the CAN bus may include but is not limited to tire pressure of each tire, tire temperature, ambient temperature, vehicle speed, acceleration and brake torque, steering angle, gross train weight, etc.

In order to ensure that the road roughness measurement data is meaningful, it is beneficial to collect and analyze the vibration data from the road noise sensors under conditions that provide the optimal results. The vibration data collected by the road noise sensors may be influenced by one or more operating conditions of the vehicle. For example, vibration data collected at high speeds, such as above 70 mph may not provide a true measure of the road roughness as the vehicle will generally experience greater vibrations at that speed irrespective of the road conditions. Similarly, other vehicle operating conditions, such as steering angle, tire pressure, etc. may also have an influence over the road noise sensor data. Therefore, it may be beneficial to collect the road noise sensor data when certain operating conditions of the vehicle are within a certain range. For example, it may be most beneficial to collect the road noise sensor data when the vehicle is operating within a speed range of 45-55 mph, or when the steering angle is between 20-25 degrees on either side, or when the ambient temperature is between 60-80° F., etc. The operating conditions and their respective ranges can be different for different vehicles, different geographies, etc. By tailoring the set of operating conditions to specific vehicles and/or geographies, it is possible to get an accurate measurement of the road roughness, which is more truly representative of the actual road condition than the traditional way of measuring road roughness that uses a standard vehicle model. Collectively, we can call these set of operating conditions as a “trigger condition.”

System 300 further includes a trigger/operating condition checking unit 304. The trigger condition checking unit 304 receives the current operating condition data from the vehicle CAN bus and the vibration data from the one or more road noise cancellation sensors. Based on the pre-determined set of operating conditions for that particular vehicle, the trigger condition checking unit 304 can determine whether the set of operating conditions is currently met by the vehicle. In one embodiment, the trigger condition checking unit can be implemented, e.g., in the VCU 110 of the vehicle 100. In another embodiment, the trigger condition checking unit 304 can be implemented in an external server. The set of operating conditions may be met during several time durations during a particular trip of the vehicle. A “trip” can be defined as the time between ignition ‘on’ and ignition ‘off’ of the vehicle. For example, during a trip, the set of operating conditions may be met three times, e.g., for a period of 10 secs, 20 secs and 1 min. The trigger condition checking unit 304 can determine the number of times the set of operating conditions is met during a trip. Based on that determination, the vibration data collected during those time intervals/durations may be used for subsequent processing to determine the road roughness measurement.

During the time durations when the set of the operating conditions are met, there may be multiple samples of data collected by the road noise sensors. In some embodiments, for each time duration, a mean, an average, or a median, etc. of the collected vibration data may be calculated and used for subsequent processing. The trigger condition checking unit 304 determines the time durations during which the set of operating conditions is met and may output an indication regarding that to the data collection unit 302. The data collection unit 302 may then send the vibration data collected during those time durations when the set of the operating conditions are met, to the road roughness measurement unit 306. The road roughness measurement unit may then analyze the vibration data collected by the road noise sensors and output a road roughness measurement that may be a single value or a set of values. In another embodiment, the data collection unit 302 may send all the vibration data collected from the road noise cancellation sensors and the trigger condition checking unit 304 may extract only the vibration data collected during those time durations when the set of the operating conditions are met, for further processing. The road roughness measurement unit 306 may determine feature data from the vibration data and generate a rule-based model for classifying the road roughness. The rule-based model may a binary model in which if a certain determined feature or features are above a respective threshold, the road can be classified as “rough” and if the certain feature or features are below the respective threshold, the road can be classified as “smooth”.

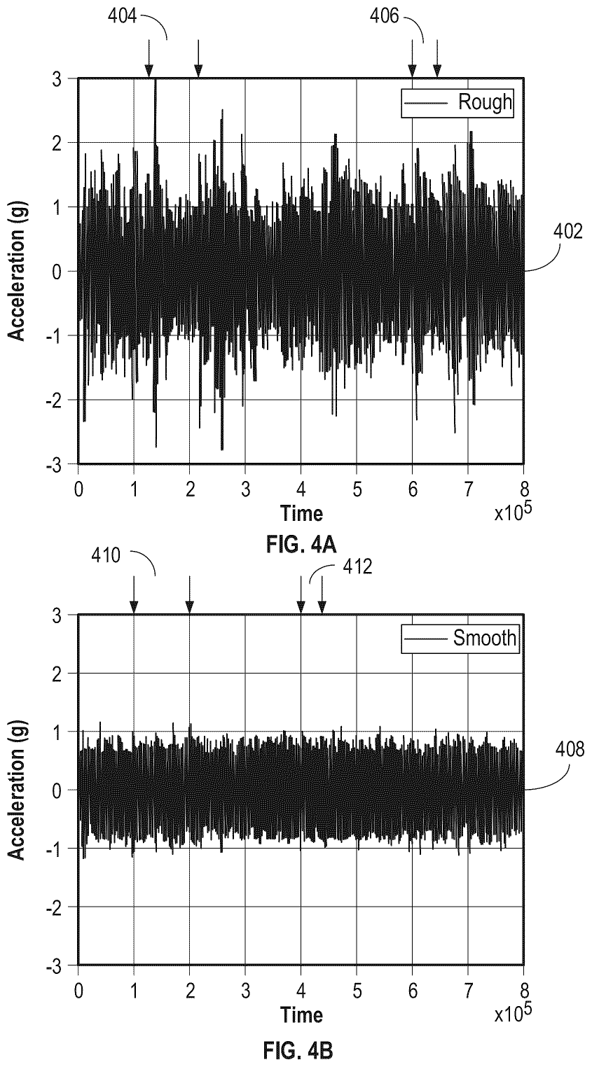

FIGS. 4A and 4B illustrate the vibration data collected for two different roads according to an embodiment of the present disclosure. FIG. 4A illustrates vibration data collected from the road noise cancellation sensors when the vehicle is being driven on road ‘A’. The vibration signature 402 illustrates the vibration data collected over time. During that time duration, the set of operating conditions is met during two time durations 404 and 406. As explained above, the vibration data collected during the two time durations 404 and 406 may be used for the road roughness measurement. The amplitude of the vibration signature 402 is illustrative of the vertical acceleration measured by the road noise cancellation sensors. In some embodiments, a window of the vibration data may be collected every 100 milliseconds, although this setting may be programmable. FIG. 4B illustrates vibration signature data 408 for road “B.” The vibration signature data is collected as the vehicle is driven on the road B. As illustrated, as the vehicle is being driven, the set of operating conditions for the vehicle are met during two time durations 410 and 412. Accordingly, the vibration data collected during these two time durations 410 and 412 is used for further analysis.

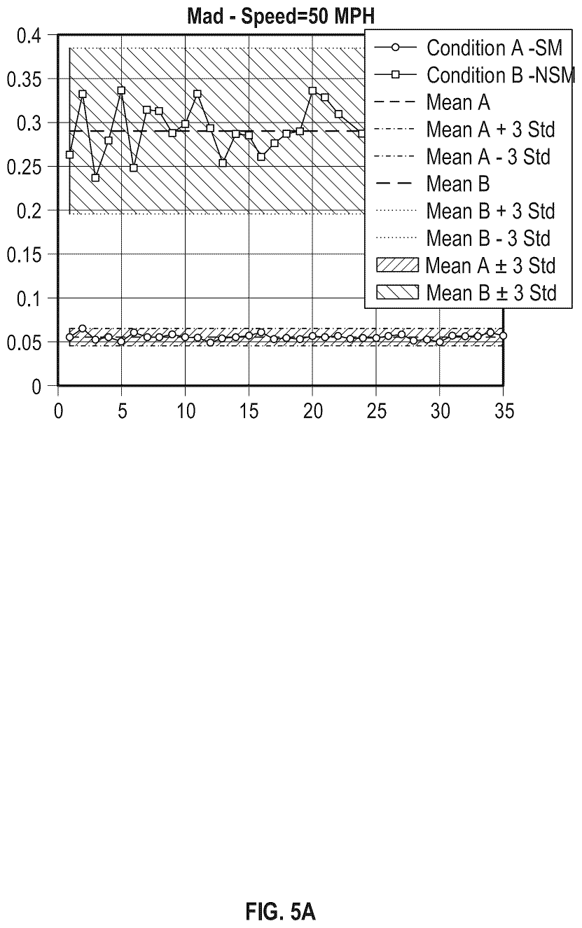

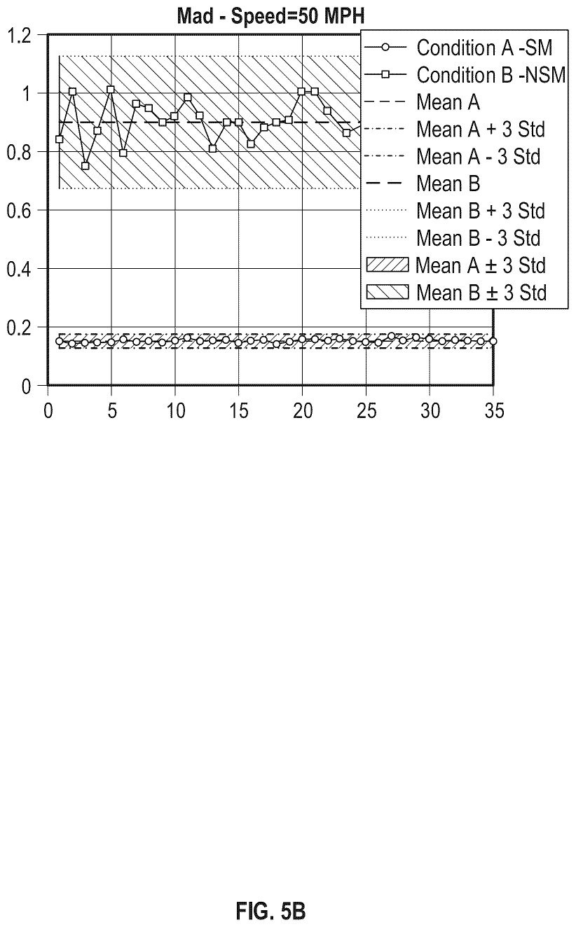

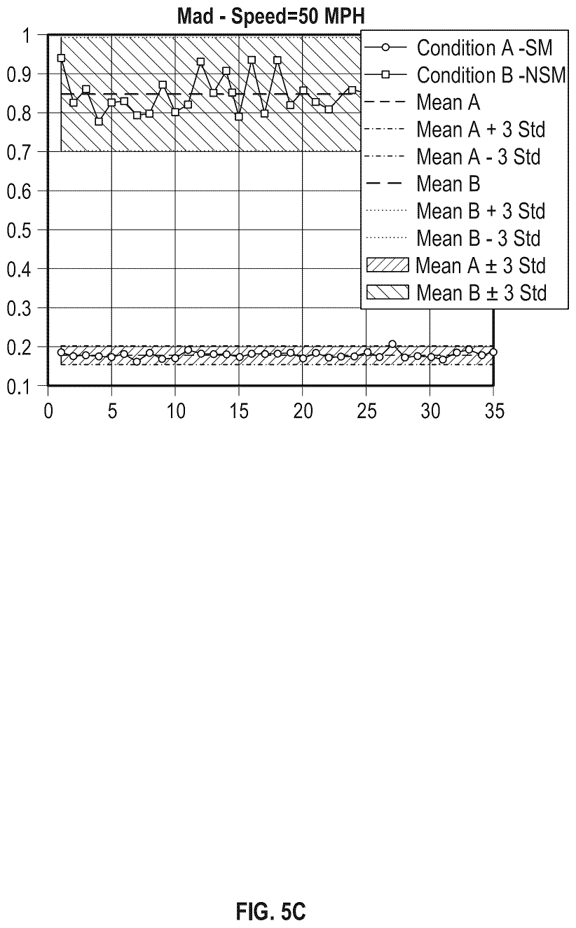

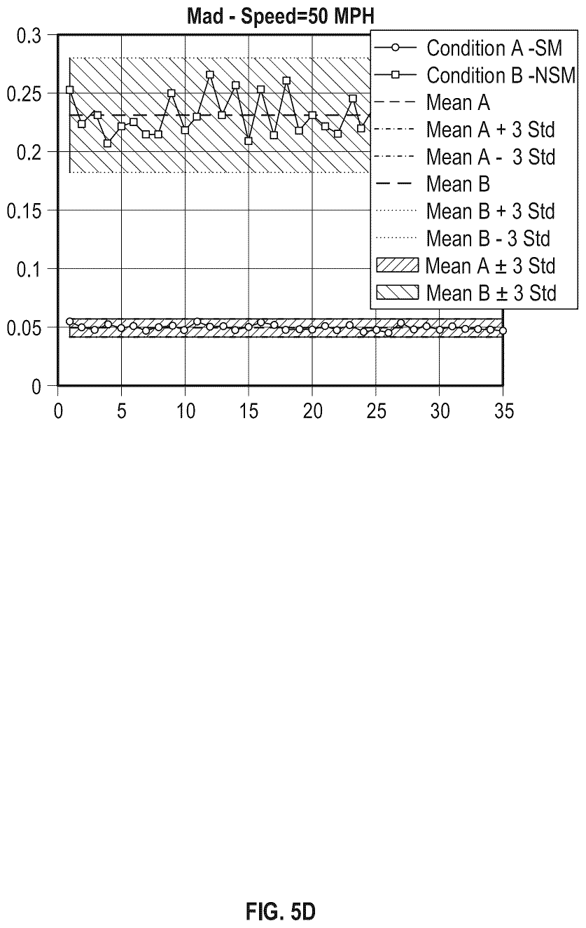

FIGS. 5A-5D illustrate feature data determined from the vibration data. This feature data is then used to determine whether a road is rough or smooth according to an embodiment of the present disclosure. Each of the FIGS. 5A-5D illustrate the feature data determined from the vibration data collected from a single road noise cancellation sensor. For example, FIG. 5A illustrates feature data determined from vibration data collected from a first road noise sensor coupled to the front right wheel of a vehicle, FIG. 5B illustrates feature data determined from vibration data collected from a second road noise sensor coupled to the rear right wheel of the vehicle, FIG. 5C illustrates feature data determined from vibration data collected from a third road noise sensor coupled to the rear left wheel of the vehicle, and FIG. 5D illustrates feature data determined from vibration data collected from a fourth road noise sensor coupled to the front left wheel of the vehicle. In this embodiment, the vertical or z-direction acceleration data is being used to determine the road roughness. The feature that is determined from the vibration data, as illustrated in FIGS. 5A-5D, is the Mean Absolute Deviation (MAD) value of the z-direction acceleration data. In one embodiment, the vibration data is divided into equal time duration windows, e.g., 10 secs, and the MAD value of the conditioned vibration data for each of the 10 sec windows is determined. The graphs in FIGS. 5A-5D illustrate the MAD values for each of such 10 sec windows of vibration data. As illustrated in FIG. 5A, the MAD values illustrated by the signature 502 represent the MAD values for a rough road while the MAD values illustrated by the signature 504 represent the MAD values for a smooth road. As can be seen, the MAD values 502 for the rough roads is significantly higher than the e MAD values 504 for the smooth road. An appropriate threshold value can be chosen to determine whether the road is rough or smooth. For example, in FIG. 5A, the threshold value can be chosen as 0.15. This threshold value will provide a good separation between a smooth road and a rough road such that the respective MAD values represented by the signatures 502 and 504 may be used to classify a particular road as smooth or rough.

In some embodiments, a mean of the MAD values+/−3 standard deviation may be used to generate the rule-based model. In real-time, the vibration data from the road noise sensors may be collected and analyzed as explained above to determine feature data and the feature data may be compared to the rule-based model generated for that vehicle to determine whether the road can be classified as smooth or rough. The classification of a road as being smooth or rough may be used as a trigger point for collecting and/or analyzing other data collected for the vehicle for other purposes such as determining vehicle fitness, road quality assessment, durability and life estimation, noise and vibration benchmarking, environmental impacts, road design and analysis, driving comfort assessment and the like. While FIGS. 5A-5D illustrates the MAD values of the z-direction acceleration, it is merely exemplary, there are several other features that may be determined from the vibration data and used for the road roughness measurement or determination. These features may be as follows.

Time-Domain features: Mean, standard deviation, Variance, root mean square (RMS), Skewness, Kurtosis, Peak, Crest Factor, Peak-to-Peak, Median, Min, Max, Range, Mean Absolute Deviation (MAD), Impulse Factor, Shape Factor, Clearance Factor, or RMS of Derivative.

Frequency-Domain features: Spectral Centroid, Spectral Bandwidth, Spectral Flatness, Spectral Rolloff, Frequency Center, RMS Frequency, Frequency, Variance, and Spectral Kurtosis.

Intrinsic Mode Functions (IMFs) Time-Domain Features: Mean, Standard, Variance, RMS, Skewness, Kurtosis, Peak, Crest Factor, Peak-to-Peak, Median, Min, Max, Range, MAD, Impulse Factor, Shape Factor, Clearance Factor, or RMS of Derivative.

IMF Frequency-Domain Features: Spectral Centroid, Spectral Bandwidth, Spectral Flatness, Spectral Rolloff, Frequency Center, RMS Frequency, Frequency Variance, and Spectral Kurtosis.

One of the approaches for durability analysis of a vehicle's underbody components is using simulation environment which provides for mimicking different loading factors and conditions and consequent effects on dynamics of components. The accuracy of durability analysis is dependent on factors which affect the gap between the reality and simulation environment. One of the examples of this factor is force/load applied from the road to the underbody components, which is a variable of the road roughness condition. Hence, accurate labeling of road roughness condition and analysis of force/load applied on the vehicle is important in minimizing the gap between the simulation environment and real-world condition. The vibration data collected from sensors along with information about the vehicle operating conditions can provide ground truth for the simulations needed for durability analysis. In addition, embodiments of the present disclosure provide for clarification of effects of load applied through road on the underbody components. Reducing the gap in simulation environment achieved by outputs of the proposed method results in accurate modeling of impact of road roughness on vehicle underbody components and improved durability analysis. This enhancement is important for analysis related to the wear patterns and/or lifespan under various road conditions. In addition, accurate measuring of road roughness in different road surfaces and conditions, such as potholes, bumps, gravel, and varying levels of road roughness improves the predictive accuracy of durability models. This predictive accuracy helps in designing products that meet or exceed performance expectations and safety standards.

Furthermore, enhancement in simulation accuracy and durability analysis provides for selection of materials and components that balance performance, cost, and longevity. In addition, an accurate simulation environment allows for the exploration of various materials and design configurations to identify the best options for meeting durability requirements without over-engineering or excessive costs. Also, enhancement in simulation accuracy is helpful for lifecycle analysis and enhancing sustainability. It allows for designing products which are easier to maintain, repair, or recycle, contributing to sustainable development goals.

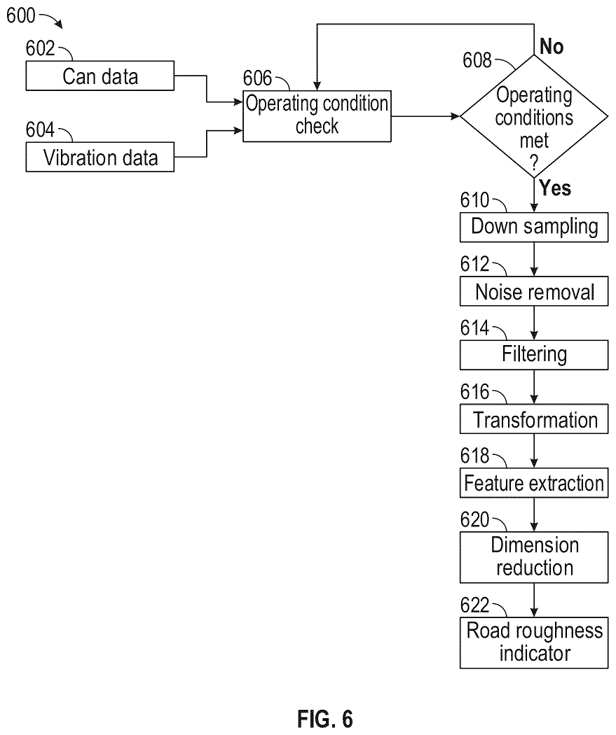

FIG. 6 illustrates a flow chart for a process 600 for determining road roughness according to an embodiment of the present disclosure. Process 600 can be fully implemented, e.g., in the vehicle 100 of FIG. 1. In another embodiment, process 600 may be implemented jointly in the vehicle and an external server. At step 602, the vehicle collects data about its current operating conditions, such as speed, acceleration, etc. as explained above. At step 604, the vibration data is collected by one or more accelerometers or road noise cancellation sensors of the vehicle. In some embodiments, steps 602 and 604 may be performed concurrently. At step 606, the operating conditions data is analyzed to determine whether the set of operating conditions are met. If it is determined that the set of operating conditions are not met at step 608, the process 600 returns to step 606 and the vehicle may continue to analyze the most current operating conditions data. If at step 608, it is determined that the operating conditions for the vehicle are met, the vibration data associated with the time duration during which the operating conditions are met is then used for further analysis. At step 610, the vibration data is down-sampled to condense the data and make is more efficient for storage and further analysis.

At step 612, noise removal is performed on the down-sampled data to remove any outliers and other noise data. At step 614, the data is subjected to band-pass filtering to extract the appropriate vibration data to be used for further analysis. At step 616, the data may be transformed to the frequency domain, e.g., using Fast Fourier Transformation techniques. After step 616, the data is in a format from which the feature data extraction may be performed. At step 618, data related to one or more features is determined from the vibration data. The list of potential features are mentioned above. Once the data for the desired features is determined from the vibration data, a dimension reduction process is performed at step 620 on the determined feature data. This process is performed to reduce the amount of feature data that needs to be processed. For example, once the feature data is determined at step 618, a determination is made as to which feature data are highly correlated with each other. Then from among the highly correlated feature data, data related to one or more features may be ignored for further processing. This helps in reducing the redundancy in the feature data. After step 620, the dimension-reduced vibration data is then analyzed to determine the road roughness indication at step 622, as explained above in relation with FIGS. 5A-5D.

Accurate measurement of road roughness measurement is beneficial in determining various aspects of the vehicle. Some of these applications are mentioned below. It is to be understood that the applications mentioned below are just an example of how the road roughness measurement may be used to improve vehicle design and performance.

Durability analysis and life prediction: road roughness assessment using vibration data collected from sensors provides for accurate reconstruction of loading profile for components of the vehicle and enhancement in life prediction.

Structural health monitoring and stress/fatigue analysis: accurate estimation of road roughness using vibration data along with identified CAN signals available in a vehicle improves the accuracy of health monitoring analysis.

Suspension adaptive control: accurate evaluating of road roughness can be used for real time adjustment of suspension design variables.

Navigation system enhancement: measurement of road roughness and accurate profiling of road conditions provide for enhancement in navigation system.

Handling and chassis stability enhancement: chassis stability and handling capability can be improved using an accurate quantification of road roughness.

Safety: accurate mapping of road roughness provides for enhancement in safety of the vehicle regardless of the road surface condition.

Advanced drive assistance system calibration and enhancement: accurate labeling and quantification of road roughness are important for calibration, triggering and control of advanced drive assistance systems.

Tire Durability and dynamic analysis: accurate labeling and quantification of road roughness provide for studying the impact of different types of road roughness on tire wear patterns, material fatigue, and the likelihood of tire malfunction. This can help in designing more durable tires suited for specific driving environments.

Road quality assessment: accurate road roughness measurement enables improved road quality profiling and assessment.

Energy optimization and regenerative braking efficiency enhancement: road roughness quantification and measurement of acceleration applied on control arm can be directly applicable to efficiency of regenerative braking system.

Driving pattern assessment: accurate quantification of road roughness provides for evaluation of driving behavior and determining the time percentage that a vehicle was used on rough or smooth road. Analyzing driving patterns leads to the development of driver assistance systems that help mitigate the impact of rough roads.

Noise and vibration benchmarking: the vibration data collected from sensors and accurate measurement of road roughness is used for evaluation of noise, vibration, and harshness (NVH) performance of a vehicle.

Road design and analysis: accurate mapping of road roughness provides useful information that can be used for design and analysis of roads.

Driving comfort assessment: accurate measurement of vibration data from sensors with minimized inference and directly from road can be used for driving comfort evaluation.

Prioritization of maintenance efforts: accurate mapping of road roughness and identification of affected regions provide insights on maintenance actions associated with the vehicle.

Historical data collection and analysis: recording historical data collected from road roughness measurement can be directly used for event analysis and correlating to historical events.

FIG. 7 depicts a block diagram of an example control server 700 upon which any of one or more techniques (e.g., methods) may be performed, in accordance with one or more example embodiments of the present disclosure. In other embodiments, the server 700 may operate as a standalone device or may be connected (e.g., networked) to other servers. In a networked deployment, the server 700 may operate in the capacity of a server machine, a client machine, or both in server-client network environments. In an example, the server 700 may act as a peer server in peer-to-peer (P2P) (or other distributed) network environments. The server 700 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The server 700 may further include a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The server 700 may additionally include a storage device (i.e., drive unit) 716, a network interface device/transceiver 720 coupled to antenna(s), and one or more sensors 728, such as a global positioning system (GPS) sensor, a compass, an accelerometer, or other sensor. The server 700 may include an output controller 734, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the server 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the server 700 and that cause the server 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 700 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
one or more processors;
one or more memories coupled to the one or more processors;
a communication interface coupled to the one or more processors; and
a plurality of sensors coupled to the one or more processors,
wherein the one or more memories store instructions, which when executed by the one or more processors cause the one or more processors to:
determine that the vehicle is in motion on a road;
capture vibration data associated with the vehicle using a plurality of sensors of the vehicle;
determine operational data associated with the vehicle;
determine, based on the operational data, that a set of operational conditions are satisfied;
determine, using the vibration data and based on the set of operational conditions being satisfied, one or more features; and
determine, based on the one or more features, a roughness indicator for the road.

2. The vehicle of claim 1, wherein the plurality of sensors include road noise cancellation sensors.

3. The vehicle of claim 1, wherein the vibration data includes acceleration data measured along one or more axes.

4. The vehicle of claim 1, wherein the set of operational conditions are met for one or more time durations and wherein to determine the one or more features, the one or more processors are further configured to only analyze vibration data captured during the one or more time durations.

5. The vehicle of claim 4, wherein the one or more features includes a mean absolute deviation value of the z-direction acceleration measurement for each of the one or more time durations.

6. The vehicle of claim 1, wherein the set of operating conditions include one or more of: a vehicle speed, a vehicle acceleration, a steering angle associated with the vehicle, tire pressure associated with the vehicle, ambient temperature of an environment in which the vehicle is operating, gross train weight of the vehicle, or brake torque associated with the vehicle.

7. The vehicle of claim 1, wherein the one or more processors are further configured to:
classify, based on the road roughness indicator, that the road is smooth; and
analyze, based in the determination that the road is smooth, the vibration data to determine one or more additional parameters for the vehicle.

8. A vehicle comprising:
one or more processors; and
a plurality of sensors coupled to the one or more processors;
wherein the one or more processors are configured to:
determine that the vehicle is currently in motion on a road;
receive, from the plurality of sensors, vibration data associated with the vehicle;
determine that a set of operating conditions associated with the vehicle are satisfied for a first time duration;
determine a first portion of the vibration data associated with the first time duration;
determine, using the first portion of the vibration data, one or more features associated with the first portion of the vibration data; and
determine, based on the one or features, a roughness indicator for the road.

9. The vehicle of claim 8, wherein the one or more processors are further configured to:
determine that the first of operating conditions associated with the vehicle are satisfied for a second time duration;
determine a second portion of the vibration data associated with the second time duration;
and
determine the one or more features further using the second portion of the vibration data.

10. The vehicle of claim 8, wherein the one or more features comprise: Mean, Standard deviation, Variance, root mean square (RMS), Skewness, Kurtosis, Peak, Crest Factor, Peak-to-Peak, Median, Min, Max, Range, mean absolute deviation (MAD), Impulse Factor, Shape Factor, Clearance Factor, RMS of Derivative, Spectral Centroid, Spectral Bandwidth, Spectral Flatness, Spectral Rolloff, Frequency Center, RMS Frequency, Frequency, Variance, or Spectral Kurtosis.

11. The vehicle of claim 8, wherein the plurality of sensors include 3-axes road noise cancellation sensors and the plurality of sensors are attached to an underbody portion of the vehicle.

12. The vehicle of claim 8, wherein the set of operating conditions include one or more of: a vehicle speed, a vehicle acceleration, a steering angle associated with the vehicle, tire pressure associated with the vehicle, ambient temperature of an environment in which the vehicle is operating, gross train weight of the vehicle, or brake torque associated with the vehicle.

13. A method comprising:
determining, by a vehicle, that the vehicle is in motion on a road;
capturing, by the vehicle, vibration data associated with the vehicle using a plurality of sensors of the vehicle;
determining, by the vehicle, operational data associated with the vehicle;
determining, by the vehicle based on the operational data, that a set of operational conditions are satisfied;
determining, by the vehicle using the vibration data and based on the set of operational conditions being satisfied, one or more features; and
determining, by the vehicle and based on the one or more features, a roughness indicator for the road.

14. The method of claim 13, wherein the plurality of sensors include road noise cancellation sensors.

15. The method of claim 13, wherein the vibration data includes acceleration data measured along one or more axes.

16. The method of claim 13, wherein the set of operational conditions are met for one or more time durations and wherein determining the one or more features includes analyzing vibration data captured during the one or more time durations.

17. The method of claim 13, wherein the one or more features includes a mean absolute deviation value of a z-direction acceleration measurement for each of the one or more time durations.

18. The method of claim 13, wherein the operational data includes one or more of: a vehicle speed, a vehicle acceleration, a steering angle associated with the vehicle, tire pressure associated with the vehicle, ambient temperature of an environment in which the vehicle is operating, gross train weight of the vehicle, or brake torque associated with the vehicle.

19. The method of claim 13, further comprising:
classifying, based on the road roughness indicator, that the road is smooth; and
analyzing, based on the determination that the road is smooth, the vibration data to determine one or more additional parameters for the vehicle.

20. The method of claim 19, wherein the one or more additional parameters are associated with one or more of: vehicle safety, road quality assessment, durability and life estimation, noise and vibration benchmarking, environmental impacts, road design and analysis, or driving comfort assessment.
